(19) United States
(12) Patent Application Publication
(10) Pub. No.: US 2024/0376563 A1
(43) Pub. Date: Nov. 14, 2024

(54) PROCESS FOR DRY BENEFICIATION OF BAUXITE MINERALS BY ELECTROSTATIC SEGREGATION

(71) Applicant: SEPARATION TECHNOLOGIES LLC, Needham, MA (US)

(72) Inventors: Kyle P. Flynn, Moseley, VA (US); Abhishek Gupta, Cambridge, MA (US); Lucas Rojas Mendoza, Watertown, MA (US)

(21) Appl. No.: 18/781,385

(22) Filed: Jul. 23, 2024

Related U.S. Application Data
(63) Continuation of application No. 17/162,044, filed on Jan. 29, 2021, now abandoned.

(51) Int. Cl. C22B 1/02; C01F 7/06; C04B 7/00; C22B 1/24; C22B 21/00

(52) U.S. Cl. CPC C22B 1/02; C01F 7/06; C04B 7/006; C22B 1/24; C22B 21/0007

(57) ABSTRACT

A tribo-electrostatic separation process for beneficiation of bauxite minerals is disclosed. The process may include one or more steps of grinding, drying, de-agglomeration, air classification and electrostatic separation.

### RELATED APPLICATION

This application is a continuation application of pending U.S. patent application Ser. No. 17/162,044, filed Jan. 29, 2021, titled PROCESS FOR DRY BENEFICIATION OF BAUXITE MINERALS BY ELECTROSTATIC SEGREGATION, which is incorporated by reference herein in its entirety for all purposes.

### BACKGROUND

Field of Invention

The present invention relates to a process for dry upgrading of bauxite ores consisting of grinding, drying, de-agglomeration, air classification and electrostatic separation.

Discussion of Related Art

U.S. Pat. No. 6,296,818 describes a chemical digestion process for treating alumina monohydrate bauxites to obtain aluminate liquor at atmospheric pressure. U.S. Pat. No. 5,279,645 describes a thermal roasting process for the removal of organic matter from gibbsite type bauxite, with the roasting conducted at 400-600 deg C.

A belt separator system is disclosed in commonly-owned U.S. Pat. Nos. 4,839,032 and 4,874,507. Commonly-owned U.S. Pat. No. 5,904,253 describes an improved belt geometry for a BSS which is claimed a system for processing non-bauxite minerals.

### SUMMARY OF INVENTION

Aspects and embodiments of the disclosure relate to a process of drying, grinding, de-agglomeration, air classification and electrostatic separation for water-free beneficiation of monohydrate and trihydrate bauxite ores. Aspects and embodiments of the disclosure are directed to a process to comminute and dry bauxite ore, and subsequently perform upgrading of the bauxite minerals by electrostatic separation to generate a bauxite ore concentrate from lower grade bauxite ores in a completely dry and water free process. The disclosure aims to enable the processing of low-grade bauxite ores (monohydrate and trihydrate) which are of marginal quality (non-metallurgical grade), or improve the quality of bauxite ores which are metallurgical or chemical grade to enhance their value or suitability for further processing. An advantage of the disclosure is that the processing method allows for the beneficiation of bauxite ores that are otherwise of marginal economic value due to low available alumina content or high reactive silica content. Furthermore, an advantage of the disclosure is that the processing is carried out in an entirely dry method without water, therefore the by-products of the separation process which are depleted in bauxite will be dry and will contain no chemical residues, therefore allowing for direct beneficial use, for example in portland cement manufacture, or to be stored as stackable dry tailings. The present invention is suitable on low temperature bauxites containing mostly gibbsite, as well as high temperature bauxites containing mostly boehmite and/or diaspore. The present invention is shown to reduce reactive silica present both as quartz and kaolinite.

One embodiment of the invention comprises a system of dry milling and drying followed by a belt type electrostatic separator system (BSS), to generate a high-grade bauxite concentrate and a dry low-grade bauxite co-product.

In another embodiment of the invention, the system comprises simultaneously dry milling and drying, followed by a belt type electrostatic separator system (BSS), to generate a high-grade bauxite concentrate and a dry low-grade bauxite co-product.

In yet another embodiment, where the ore is already suitably fine, such as is the case with wet tailings, the system comprises thermal drying followed by de-agglomeration and followed by a belt type electrostatic separator system (BSS), to generate a high-grade bauxite concentrate and a dry low-grade bauxite co-product.

In yet another embodiment, where the ore is already suitably fine, such as is the case with wet tailings, the system comprises simultaneous thermal drying and mechanical de-agglomeration, followed by a belt type electrostatic separator system (BSS), to generate a high-grade bauxite concentrate and a dry low-grade bauxite co-product.

In yet another embodiment, the system comprises dry milling and drying, followed by belt separation in scavenging or cleaning configuration.

In yet another embodiment, where the ore is already suitably fine, the system comprises thermal drying and de-agglomeration, followed by belt separation in scavenging or cleaning configuration.

In yet another embodiment, the system comprises dry milling and drying, followed by one or multiple particle size segregation steps and belt separation of one or multiple fine and coarser fractions.

In yet another embodiment, where the ore is already suitably fine, the system comprises thermal drying and de-agglomeration, followed by one or multiple particle size segregation steps and belt separation of one fine and coarser fractions.

In accordance with one or more aspects, a method for beneficiation of bauxite ore is disclosed. The method may comprise providing a source of bauxite ore, drying the bauxite ore to achieve a moisture content of less than about 4.0% by weight, and preferably less than about 2.0% by weight, and separating the bauxite ore with a triboelectric electrostatic belt-type separator or belt separator system (BSS) to generate a bauxite rich concentrate which is enriched in total Al2O3 and/or available alumina, and reduced in total SiO2 and/or reactive silica, wherein the method is water-free.

In some aspects, the source of bauxite ore is characterized by a d90 particle size of about 200 microns or less. The source of bauxite ore may be characterized by a moisture content of greater than about 10% by weight. The method may be carried out in a completely dry metallurgical route.

In some aspects, the method may further comprise grinding the source of bauxite ore such that 90% of the bauxite ore particles (d90) are finer than about 200 microns. The method may further comprise mechanically de-agglomerating the dried bauxite ore prior to separation using a high shear impact device, e.g. a pin mixer or a hammer mill, pin mill or rotor mill. Grinding and drying of the bauxite ore may be conducted in the same apparatus, e.g. an air swept mill such as a vertical roller mill, hammer mill, pin mill or rotor mill. Drying and mechanical de-agglomeration of the bauxite ore may be conducted in the same apparatus, such as an air swept, agitated flash dryer system.

In some aspects, the source of bauxite ore may be a monohydrate and/or a trihydrate bauxite ore. The source of bauxite ore may be a metallurgical grade bauxite ore. The source of bauxite ore may be a non-metallurgical grade bauxite ore.

In some aspects, the method may further comprise introducing the bauxite-rich concentrate to an alumina refining operation or Bayer process. The separating step may further generate a co-product suitable for use in the manufacturing of cement or cement clinker. In at least some aspects, the co-product does not require pretreatment to remove sodium prior to being used to manufacture cement clinker or cementitious products. The method may further comprise storing a co-product of the separating step as stackable dry tailings.

In some aspects, the bauxite ore may be beneficiated at a rate of feed greater than about 37 tons per hour per meter of electrode width. The bauxite rich concentrate may be characterized by less than about 4% reactive silica by weight, e.g. about 3% reactive silica. The amount of iron present in the bauxite rich product may be reduced by about 0% to about 30% on a relative basis. The amount of titania (TiO2) present in the bauxite rich product may be reduced by about 0% to about 75% on a relative basis. The amount of kaolinite present in the bauxite rich product may be reduced by about 0% to about 50% on a relative basis. The amount of quartz present in the bauxite rich product may be reduced by about 20% to about 80% on a relative basis. An amount of reactive silica present per unit of available alumina may be reduced by about 10% to about 65% on a relative basis.

In some aspects, a ratio of bauxite to available alumina may be decreased by between about 8% and about 27% in relative terms. The ratio of available alumina to reactive silica in the bauxite rich product (A/S) may be increased by between about 20% and about 200% in relative terms. A ratio of bauxite to total Al2O3 may be decreased by between about 2% and about 30% in relative terms.

In some aspects, the dry, bauxite-depleted co-product from the first BSS stage may be processed by a second BSS stage in a scavenging configuration in which the bauxite rich product from the secondary BSS is returned as feed to the primary BSS stage. The dry, bauxite-depleted co-product from the first BSS stage may be processed by a second BSS stage in a scavenging configuration. The bauxite concentrate from the first BSS may be processed by a second BSS in a cleaning configuration.

In some aspects, the dry, bauxite-depleted co-product from the first BSS may be processed by a second BSS in a scavenging configuration in which the bauxite rich product from the secondary BSS is returned as feed to the primary BSS, and in which the bauxite rich concentrate from the first BSS may be processed by a second BSS in a cleaning configuration. The dry, bauxite-depleted co-product from the first BSS may be processed by a second BSS in a scavenging configuration, and in which the bauxite rich concentrate from the first BSS may be processed by a second BSS in a cleaning configuration. In at least some aspects, the dry, bauxite-depleted co-product from the first BSS may be processed by a second BSS in a scavenging configuration in which the bauxite rich product from the secondary BSS may be returned as feed to the primary BSS. The dry, bauxite-depleted co-product from the first BSS may be processed by a second BSS in a scavenging configuration.

In some aspects, the method may further comprise air classifying the processed bauxite ore to provide a fine fraction and a coarse fraction. Either or both the fine fraction or the coarse fraction from the air separator classification system may be processed with the BSS to generate the bauxite rich concentrate which is enriched in total Al2O3 and/or available alumina, and reduced in total SiO2 and/or reactive silica. The fine fraction may be processed with the BSS to generate the bauxite-rich concentrate which is enriched in total Al2O3 and/or available alumina, and reduced in total SiO2 and/or reactive silica.

In some aspects, the method may further comprise introducing the fine fraction to at least one further air separator classification device. The coarser fraction(s) from one or more of the at least one further air classification stages preceding the final air classification stage may be processed via BSS. The fine fraction from the final air classification stage may be processed via BSS.

These and other features and benefits of the present invention will be more particularly understood from the following detailed description.

### BRIEF DESCRIPTION OF THE DRAWINGS

The foregoing and other advantages of the application will be more fully appreciated with reference to the following drawings in which:

FIG. 1 illustrates a diagram of an embodiment of a system for crushing, dry grinding, drying, and belt separation of bauxite ore.

FIG. 2 Illustrates another embodiment of a system for crushing, dry grinding, drying and belt separation of bauxite ore.

FIG. 3 Illustrates another embodiment of a system for drying, de-agglomerating and belt separation of bauxite ore that is already suitably fine.

FIG. 4 Illustrates another embodiment of a system for drying, de-agglomerating and belt separation of bauxite ore that is already suitably fine.

FIG. 5 Illustrates another embodiment of a system for crushing, dry grinding, drying and belt separation of bauxite ore.

FIG. 6 Illustrates another embodiment of a system for drying, de-agglomerating and belt separation of bauxite ore that is already suitably fine.

FIG. 7 Illustrates another embodiment of a system for crushing, dry grinding, drying and belt separation of bauxite ore.

FIG. 8 Illustrates another embodiment of a system for drying, de-agglomerating and belt separation of bauxite ore that is already suitably fine.

FIG. 9 Illustrates another embodiment of a system for crushing, dry grinding, drying and belt separation of bauxite ore.

FIG. 10 Illustrates another embodiment of a system for drying, de-agglomerating and belt separation of bauxite ore that is already suitably fine.

FIG. 11 illustrates a diagram of an embodiment of a system for crushing, dry grinding, drying, particle size segregation and belt separation of bauxite ore.

FIG. 12 illustrates a diagram of an embodiment of a system for drying, de-agglomerating, particle size separation and belt separation of bauxite ore that is already suitably fine.

FIG. 13 illustrates another embodiment of a system for crushing, dry grinding, drying, particle size segregation and belt separation of bauxite ore.

FIG. 14 illustrates another embodiment of a system for drying, de-agglomerating, particle size separation and belt separation of bauxite ore that is already suitably fine.

FIG. 15 illustrates another embodiment of a system for crushing, dry grinding, drying, particle size segregation and belt separation of bauxite ore.

FIG. 16 illustrates another embodiment of a system for drying, de-agglomerating, particle size separation and belt separation of bauxite ore that is already suitably fine.

FIG. 17 illustrates another embodiment of a system for crushing, dry grinding, drying, particle size segregation and belt separation of bauxite ore.

FIG. 18 illustrates another embodiment of a system for drying, de-agglomerating, particle size separation and belt separation of bauxite ore that is already suitably fine.

### DETAILED DESCRIPTION

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

The refining of bauxite ore by the Bayer process is the primary method of generating alumina. Bauxite ores are graded upon their available alumina content which represents the alumina that can be recovered by the Bayer process, and by their reactive silica content. High reactive silica is undesirable when refining bauxite in the Bayer process as it increases the consumption of caustic soda (NaOH), reduces the alumina available to the process, contributes to alumina losses and leads to more rejected material as alumina refinery residues (ARR) or red mud. Bauxites are generally considered high in reactive silica if they contain a reactive silica content of more than 8% by weight. Bauxite with reactive silica content above 8% is generally considered non-economic to process, and therefore is sold at a deep discount, or is considered waste.

Bauxites consist of a mixture of trihydrate minerals (gibbsite) and monohydrate minerals (boehmite and diaspore). At low leaching temperatures of 140 deg C. or less, only the gibbsite fraction of the bauxite is reactive and thus only the gibbsite content of the bauxite contributes to the available alumina. At high leaching temperatures of 180 deg C. or greater, both the trihydrate and monohydrate bauxite minerals are reactive. Bauxites can thus be considered as being suitable for low temperature processing or high temperature processing, depending on the ratio of trihydrate to monohydrate minerals contained in the bauxite. The refining temperature also determines which gangue minerals react, with kaolinite being reactive at both lower and higher temperatures, but quartz being reactive only during higher temperature refining. Reactive silica from kaolinite and quartz both contribute to caustic soda loss in the Bayer process, however, reactive silica from quartz also results in a loss of alumina during the desilication phase. Therefore, both the mineralogy and amount of the gangue minerals contained in the bauxite is of importance to the bauxite refiner, as it determines the cost of refining.

Wet processing methods of bauxite beneficiation include crushing, sieving, washing, scrubbing and dewatering of the ore. Screening and washing of bauxite ores is effective in reducing silicates for ores in which the silicates are preferentially concentrated in the finer particle size fractions, as the finer particles size fractions report to the tailings. Screening methods are not selective towards reducing silicates, and thus fine bauxite minerals are also removed as a result of the screening process. Froth flotation has been employed for certain low-grade bauxite ores, however, has not been shown to be highly selective at rejecting kaolinite. Wet processing methods are undesirable due to the large volumes of water required, the need to subsequently dewater or dry the product and the wet tailings which must be stored in tailings dams and monitored to prevent accidental release.

Water-free methods of bauxite beneficiation are limited to dry sieving to remove impurities that are segregated in a particular size fraction of the bauxite. In practice, such screening operations are limited to relatively coarse particles. The selectivity of sieving is typically low, with significant bauxite losses typically incurred. Dry sieving is effective for ores in which the silicates are preferentially concentrated in the finer particle size fractions. Magnetic separation of bauxite has been studied for selectively removing iron containing contaminants, however magnetic separation of bauxite ores has not been widely implemented in commercial operation. Magnetic separation is effective only in reducing the magnetic iron minerals from bauxite, and therefore is not selective for reducing silica which is non-magnetic. The limitations of dry magnetic separators on fine particles are well understood due to the effects of air currents, particle to particle adhesion, and particle to rotor adhesion. Fine particles are highly influenced by the movement of air currents, and thus it is not practical to sort fine particles by dry magnetic processing methods in which the particles are required to follow a trajectory imparted by the movement of the magnetic separator belt.

Electrostatic separators can be classified by the method of charging employed. The three basic types of electrostatic separators include; (1) high tension roll (HTR) ionized field separators, (2) electrostatic plate (ESP) and screen static (ESS) field separators and (3) triboelectric separators, including belt separator systems (BSS).

High tension roll (HRT) systems are unsuitable for removing silicates from bauxite ores, as both the silicates and bauxite ores are electrically insulating (i.e.—non-conductive) and therefore no driving force exists to impart a conductivity-based separation. Iron gangue minerals are electrically conductive and could in principle be separated from bauxite ores on the basis of electrical conductivity differences. However, HTR systems are limited in their ability to process fine particles and are thus not suitable for removing iron gangue minerals which are present as fine particles, as fine particles are influenced by air currents and are therefore not suitable for sorting by any means which relies on imparted momentum. In addition, HTR devices are inherently limited in the rates of fine particles they are able to process due to the requirement that each individual particle contact the drum roll. As particle size decreases, the surface area of the particles per unit of weight increases dramatically, thus reducing the effective processing rate of such devices, and making them unsuitable for processing fine particles at commercially relevant rates. In addition to these operational limitations, the fine particles that are present in the non-conducting fraction are difficult to remove from the rolls once attached, due to the strong electrostatic force relative to the mass of the particles. The limitations of such devices on fine particles include fine particles adhere to the surface of the drum, are challenging to remove and degrade the ability of the conductive particles to make contact with the drum. Therefore, such separators are not suitable for very fine bauxite ores. Electrostatic separation(ES) of bauxite ore has not been utilized in commercial application.

Belt separator systems (BSS) are used to separate the constituents of particle mixtures based on the charging of the different constituents by surface contact (i.e. the triboelectric effect). BSS offer advantages over HRT, ESP and ESS electrostatic separators including free fall or drum roll separators as they are ideally suited to processing fine materials with high throughput. BSS require that particles contain low surface moisture, be free flowing and be physically detached (i.e.—liberated) such that the impurities and the high value minerals are contained in separate particles.

BSS may be operated in different configurations including in multiple stages of separation to either enhance bauxite recovery or improve the grade of the bauxite mineral rich product. For example, a BSS can consist of a first stage or rougher stage separation, which generates two products, a bauxite rich mineral product or concentrate and a gangue mineral rich co-product or tailings. The tailings from the rougher stage may be subsequently processed in a second stage of BSS, called a scavenging stage, to recover additional bauxite minerals. The bauxite rich product or concentrate may also be processed in a second stage of BSS, called a cleaning stage.

Aspects and embodiments of this disclosure are directed to a water-free process for beneficiating bauxite to reduce the reactive and total silica and increase the available alumina. Advantages of this system include the eliminated need for water for processing, elimination of wet tailings produced by wet processing methods and the opportunity for reuse of the dry tailings as low-grade bauxite for cement manufacture, or other purposes. Furthermore, the system allows for beneficiation of bauxites that were previously not able to be processed due to the presence of very finely disseminated impurities which are not liberated at coarser particle sizes required for screening. Low-grade bauxite wastes or tailings from wet screening operations may be upgraded using the system described. The system is applicable for processing both metallurgical grade and non-metallurgical grade bauxites, and for both low temperature (gibbsite) bauxites, as well as high temperature bauxites which contain significant amounts of boehmite and/or diaspore.

Further advantage of the system is that it does not require high temperature calcining or roasting of the bauxite ores. The system instead requires only the removal of surface moisture by flash drying, with the temperature of the bauxite ore exiting the dryer not exceeding 150 deg C. Higher temperature drying using a rotary dryer may be desirable in some circumstances.

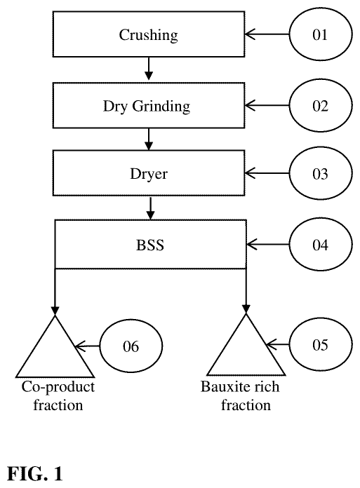

Aspect and embodiments of this disclosure are directed to a system of concentrating bauxite ores in a completely water-free method, as illustrated in FIG. 1. The low-grade bauxite ore is introduced to a crushing system (01) to reduce the ore to a particle size suitable for fine grinding. The crushing system is followed by a dry grinding stage (02) for the crushed ore. The bauxite ore is reduced to a fine particle size suitable for processing with an electrostatic belt separator system (BSS). A particle size with a d90 less than 200 microns, and a d50 less than 50 microns is desirable. The dry ground ore is next introduced into a dryer (03) to reduce the free surface moisture of the ore prior to electrostatic separation. The optimal free surface moisture, as measured by loss in weight at 110 deg C. until constant weight is reached, is obtained at moistures below 4%, and preferably between 2.0% and 0.1% moisture. The dried ore is then introduced into a BSS (04) where it is separated into a bauxite rich fraction (05) suitable for use as metallurgical grade bauxite and/or other high value bauxite applications. The gangue minerals are concentrated in a co-product fraction (06) which also contains some residual bauxite, and is suitable as an input to the manufacture of portland cement or cement clinker or may be stacked as dry tailings or moisture conditioned tailings.

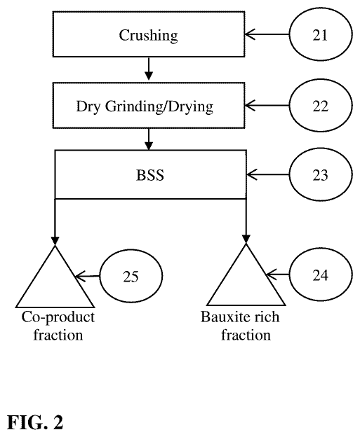

In another embodiment, illustrated in FIG. 2, the dry grinding stage may be combined with a simultaneous drying stage (22) that reduces the surface moisture content of the bauxite ore to a level suitable for electrostatic separation using a BSS. This grinding and simultaneous drying may occur in an air swept milling device such as a vertical roller mill or an impact mill apparatus such as a hammer mill, rotor mill or pin mill. Optimal surface moisture, as measured by loss in weight at 110 deg C. until constant weight is reached, is obtained at moisture levels below 2.0% moisture. The ground bauxite powder, which has been dried to the suitable moisture content, is processed by a BSS (23) which fractionates the ore into a bauxite rich product (24) and a dry, bauxite-depleted co-product fraction (25) suitable as an input to the manufacture of portland cement or cement clinker or may be stacked as dry tailings or moisture conditioned tailings.

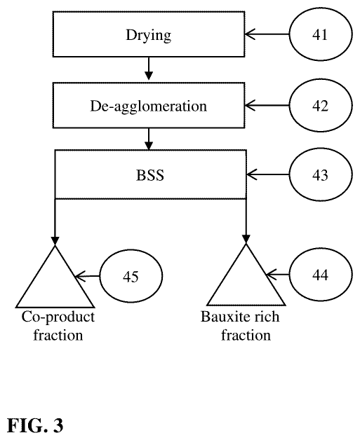

FIG. 3 illustrates another embodiment of a system and method, wherein the ore is suitably fine but which contains high residual moisture, as in the case with tailings from wet processing. For these ores which are already suitably fine in particle size but contain high moisture, the process entails first drying the ore in a rotary dryer (41) followed by mechanical de-agglomeration (42). Mechanical de-agglomeration may be performed by an impact mill, such as a hammer mill, rotor mill or pin mill, or a high shear mixing device such as a pin mixer. The dried and de-agglomerated bauxite powder is then processed by a BSS (43) which fractionates the ore into a bauxite rich product (44) and a dry, bauxite-depleted co-product fraction (45) suitable as an input to the manufacture of portland cement or cement clinker or may be stacked as dry tailings or moisture conditioned tailings.

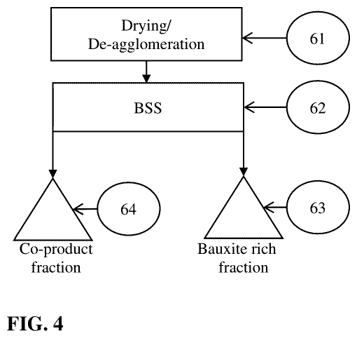

FIG. 4 illustrates another embodiment of a system and method, wherein the ore is suitably fine in particle size, but which contains high residual moisture, as in the case with tailings from wet processing. For these ores which are already suitably fine in particle size but contain high moisture, the process entails a simultaneous drying and de-agglomeration stage (61) using an air swept, agitated flash dryer system. The dried and de-agglomerated bauxite powder, which has been dried to the suitable moisture content, is processed by a BSS (62) which fractionates the ore into a bauxite rich product (63) and a dry bauxite-depleted co-product fraction (64).

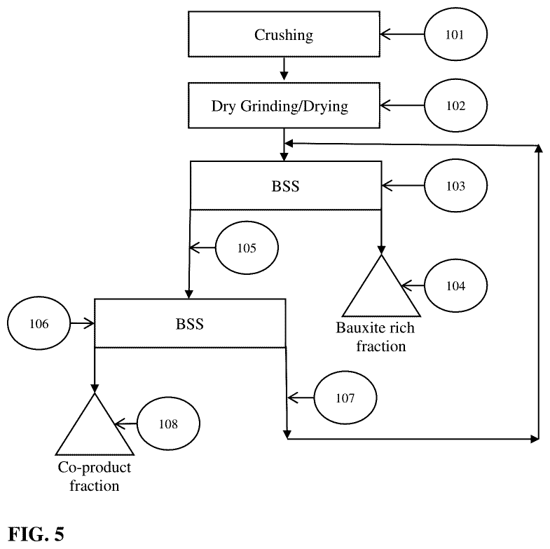

FIG. 5 illustrates another embodiment of a system and method, wherein the ore is introduced to a crushing system (101) to reduce the ore to a particle size suitable for fine grinding. The crushing system is followed by a dry grinding and drying stage, which may be combined to occur in the same apparatus (102). This grinding and simultaneous drying may occur in an air swept milling device such as a vertical roller mill or an impact mill apparatus such as a hammer mill, rotor mill or pin mill. The ground bauxite powder, which has been dried to the desired moisture content, is processed by an initial stage BSS (103) which fractionates the ore into a bauxite rich product (104) and a dry, bauxite-depleted co-product fraction (105). The dry co-product (105) from the primary BSS stage (103), is processed by a secondary BSS (106) in a scavenging operation, where the bauxite enriched product (107) from the scavenging stage BSS (106) is recirculated to the primary BSS stage (103). The waste fraction from the secondary BSS (108) is suitable as an input to the manufacture of portland cement or cement clinker or may be stacked as dry tailings or moisture conditioned tailings.

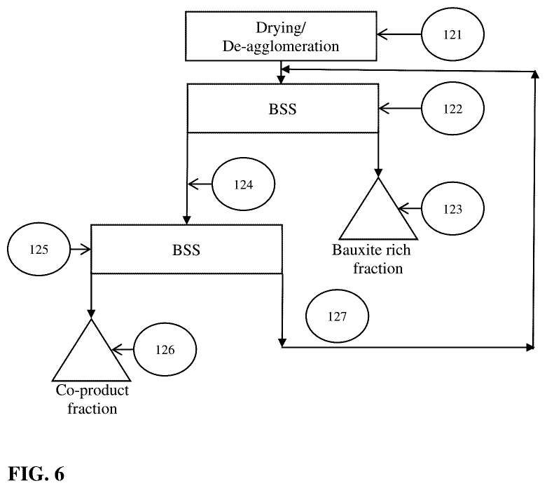

FIG. 6 illustrates another embodiment of a system and method, wherein the ore is suitably fine, but which contains high residual moisture, as may be the case with tailings from wet processing. For these ores which are already suitably fine in particle size but contain high moisture, the process may entail a simultaneous drying and de-agglomeration stage (121) using an air swept, agitated flash dryer system or similar device. The dried and de-agglomerated bauxite powder, which has been dried to the suitable moisture content, is processed by an initial stage BSS (122) which fractionates the ore into a bauxite rich product (123) and a dry bauxite-depleted co-product fraction (124). The dry co-product (124) from the primary stage BSS (122), is processed by a secondary scavenging stage BSS (125) and the bauxite enriched product (127) from the scavenging BSS (125) is recirculated as input feed material to the primary stage BSS (122). The waste fraction from the secondary scavenging stage BSS (126) is suitable as an input to the manufacture of portland cement or cement clinker or may be stacked as dry tailings or moisture conditioned tailings.

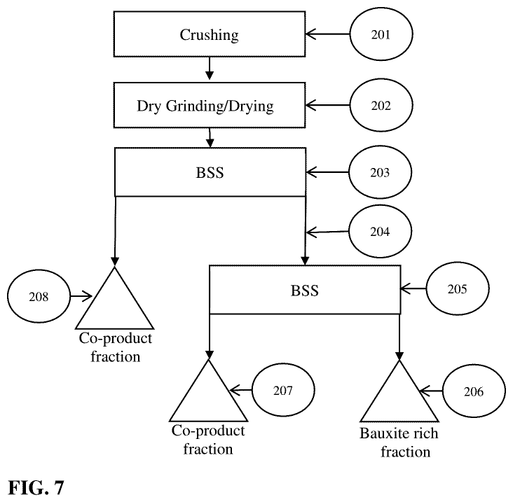

FIG. 7 illustrates another embodiment of a system and method, wherein the ore is introduced to a crushing system (201) to reduce the ore to a particle size suitable for fine grinding. The crushing system is followed by a dry grinding and drying stage (202), which may be combined to occur in the same apparatus. This grinding and simultaneous drying may occur in an air swept milling device such as a vertical roller mill or an impact mill apparatus such as a hammer mill, rotor mill or pin mill. The ground bauxite powder, which has been dried to the suitable moisture content, is processed by a primary stage BSS (203) which fractionates the ore into a bauxite rich product (204) and a dry, bauxite-depleted co-product fraction (208). The dry bauxite rich product (204) from the primary BSS stage (203) is processed by a secondary stage BSS (205) in a cleaner configuration which fractionates the ore into a bauxite rich product (206) and a dry, bauxite-depleted co-product fraction (207). The waste fractions from the primary BSS (208) and the secondary BSS (207) are suitable as an input to the manufacture of portland cement or cement clinker or may be stacked as dry tailings or moisture conditioned tailings. The waste or co-product fraction (207) from the secondary cleaner stage BSS (205) may also be suitable for introduction with the feed bauxite ore entering the primary stage BSS (203).

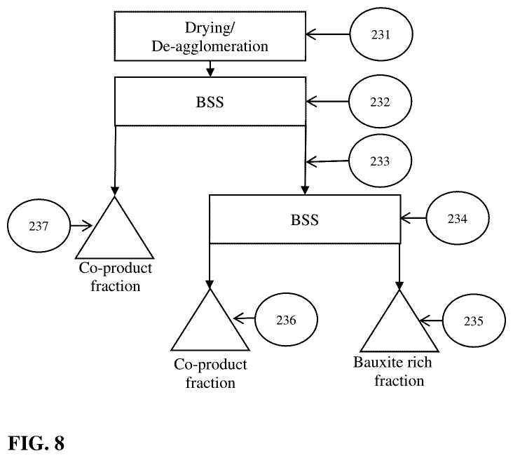

FIG. 8 illustrates another embodiment of a system and method, wherein the ore is suitably fine, but which contains high residual moisture, as in the case with tailings from wet processing. For these ores which are already suitably fine in particle size but contain high moisture, the process may entail a simultaneous drying and de-agglomeration stage (231) using an air swept, agitated flash dryer system. The dried and de-agglomerated bauxite powder, which has been dried to the suitable moisture content, is processed by a primary stage BSS (232) which fractionates the ore into a bauxite rich product (233) and a dry bauxite-depleted co-product fraction (237). The dry bauxite rich product (233) from the primary BSS stage (232), is processed by a secondary BSS (234) in a cleaner configuration which fractionates the ore into a bauxite rich product (235) and a dry, bauxite-depleted co-product fraction (236). The waste fractions from the primary BSS (237) and the secondary cleaner stage BSS (236) are suitable as an input to the manufacture of portland cement or cement clinker or may be stacked as dry tailings or moisture conditioned tailings. The waste or co-product fraction (236) from the secondary cleaner stage BSS (234) may also be suitable for introduction with the feed bauxite ore entering the primary stage BSS (232).

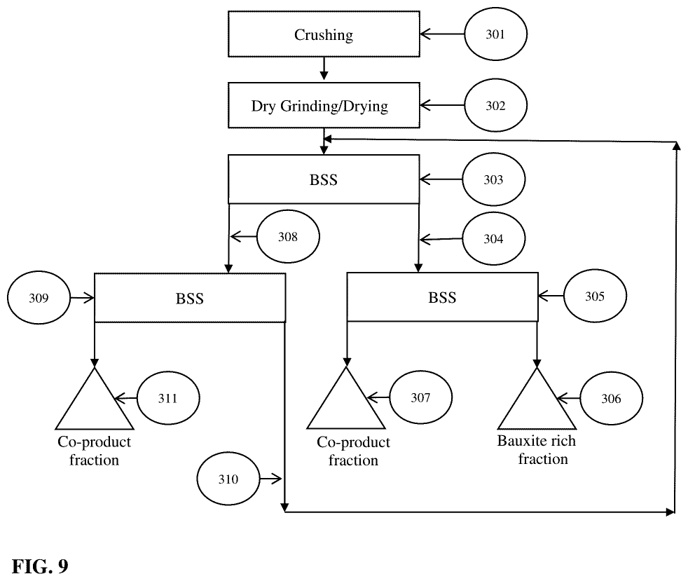

FIG. 9 illustrates another embodiment of a system and method, wherein the ore may be introduced to a crushing system (301) to reduce the ore to a particle size suitable for fine grinding. The crushing system is followed by a dry grinding and drying stage, which may be combined (302). This grinding and simultaneous drying may occur in an air swept milling device such as a vertical roller mill or an impact mill apparatus such as a hammer mill, rotor mill or pin mill. The ground bauxite powder, which has been dried to the suitable moisture content, is processed by a BSS (303) which fractionates the ore into a bauxite rich product (304) and a dry, bauxite-depleted co-product fraction (308). The dry co-product (308) from the primary BSS (303), is processed by a secondary BSS (309) and the product from the BSS (310) is recirculated to the primary BSS (303). The dry bauxite rich product (304) from the primary BSS (303), is processed by a secondary BSS (305) which fractionates the ore into a bauxite rich product (306) and a dry, bauxite-depleted co-product fraction (307). The waste fractions from the secondary scavenging stage BSS (311) and the secondary cleaning stage BSS (307) are suitable as an input to the manufacture of portland cement or cement clinker or may be stacked as dry tailings or moisture conditioned tailings. Additionally, the co-product fraction (307) from the secondary cleaning stage BSS (305) may also be returned to the primary stage BSS (303) as feed.

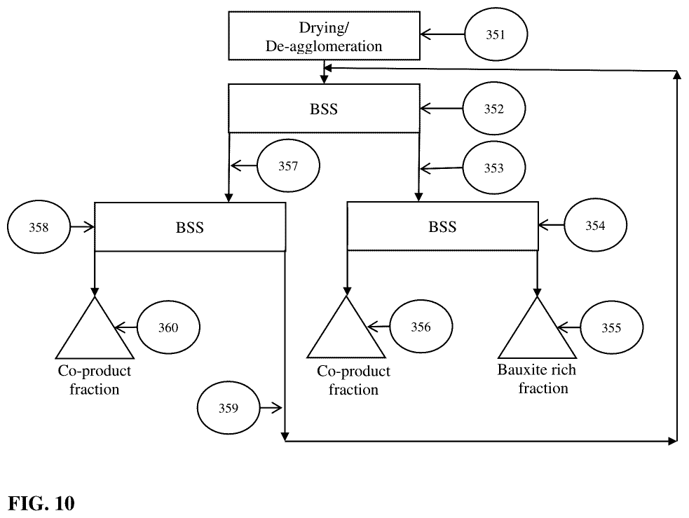

FIG. 10 illustrates another embodiment of a system and method, wherein the ore is suitably fine, but which contains high moisture. For these ores which are already suitably fine in particle size but contain high moisture, the process may entail a simultaneous drying and de-agglomeration stage (351) using an air swept, agitated flash dryer system. The dried and de-agglomerated bauxite powder, which has been dried to the suitable moisture content, is processed by a primary stage BSS (352) which fractionates the ore into a bauxite rich product (353) and a dry bauxite-depleted co-product fraction (357). The dry co-product (357) from the primary BSS (352), is processed by a secondary BSS (358) in a scavenger configuration and the bauxite rich product (359) from the scavenger stage BSS (358) is recirculated to the primary stage BSS (352) as feed. The dry bauxite rich product (353) from the primary stage BSS (352), is processed by a secondary BSS (354) in a cleaner configuration which fractionates the ore into a bauxite rich product (355) and a dry, bauxite-depleted co-product fraction (356). The co-product fraction (360) from the scavenger secondary BSS (358) and the co-product fraction (356) from the cleaner secondary BSS (354) are suitable as an input to the manufacture of portland cement or cement clinker or may be stacked as dry tailings or moisture conditioned tailings. Additionally, the co-product fraction (356) from the cleaner secondary BSS (354) may also be returned to the primary stage BSS (352) as feed.

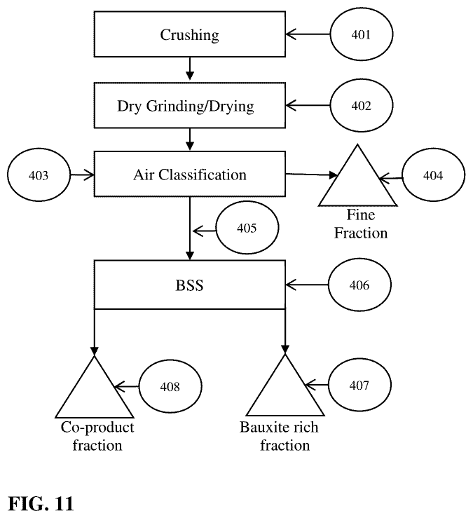

FIG. 11 illustrates another embodiment of a system and method, wherein the ore may be introduced to a crushing system (401) to reduce the ore to a particle size suitable for fine grinding. The crushing system is followed by a dry grinding and drying stage, which may be combined (402) in a single apparatus, or may occur in separate devices. The ground bauxite powder, which has been dried to the suitable moisture content is introduced to a dynamic air classification system, or cyclone system (403) that performs a segregation based on particle size. At the air classification or cyclone system (403) the ground bauxite powder is split into a coarse particle size fraction (405) and a fine particle size fraction (404). The coarse fraction from the air classification system (405) is then processed by a BSS (406) which fractionates the ore into a bauxite rich product (407) and a dry, bauxite-depleted co-product fraction (408) suitable as an input to the manufacture of portland cement or cement clinker or may be stacked as dry tailings or moisture conditioned tailings. The fine fraction (404) from the air classification system (403) may be further processed with suitable technology, including BSS.

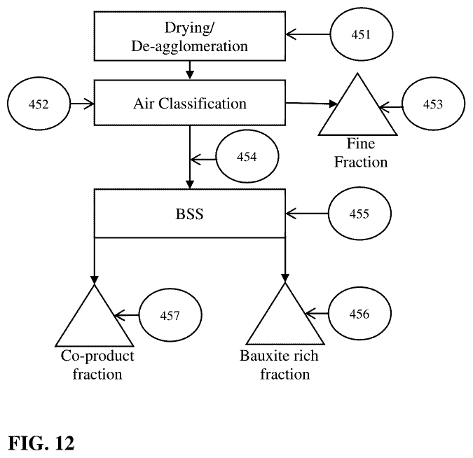

FIG. 12 illustrates another embodiment of a system and method, wherein the ore is suitably fine, but which contains high moisture. For these ores the process may entail a simultaneous drying and de-agglomeration stage (451) using an air swept, agitated flash dryer system. The ground bauxite powder, which has been dried to the suitable moisture content is introduced to a dynamic air classification system, or cyclone system (452) that performs a segregation based on particle size. At the air classification or cyclone system (452) the ground bauxite powder is split into a coarse particle size fraction (454) and a fine particle size fraction (453). The coarse fraction from the air classification system (454) is then processed by a BSS (455) which fractionates the ore into a bauxite rich product (456) and a dry, bauxite-depleted co-product fraction (457) suitable as an input to the manufacture of portland cement or cement clinker or may be stacked as dry tailings or moisture conditioned tailings. The fine fraction (453) from the air classification system (452) may be further processed with suitable technology, including BSS.

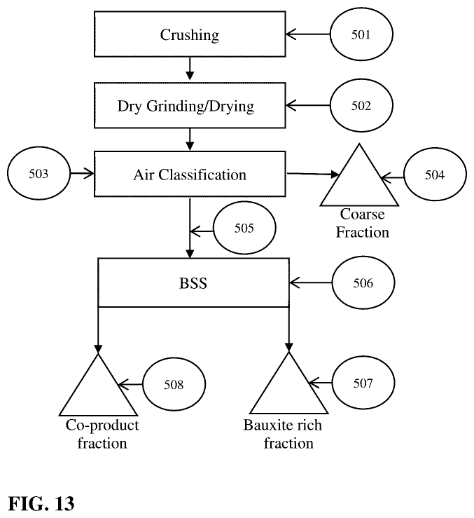

FIG. 13 illustrates another embodiment of a system and method, wherein the ore is introduced to a crushing system (501) to reduce the ore to a particle size suitable for fine grinding. The crushing system is followed by a dry grinding and drying stage, which may be combined (502). The ground bauxite powder, which has been dried to the suitable moisture content is introduced to a dynamic air classification system, or cyclone system (503) that performs a segregation based on particle size. At the air classification or cyclone system (503) the ground bauxite powder is split into a coarse particle size fraction (504) and a fine particle size fraction (505). The fine fraction (505) from the air classification system (503) is then processed by a BSS (506) which fractionates the ore into a bauxite rich product (507) and a dry, bauxite-depleted co-product fraction (508). The coarse fraction (504) from the air classification system (503) may be further processed with suitable technology, including BSS.

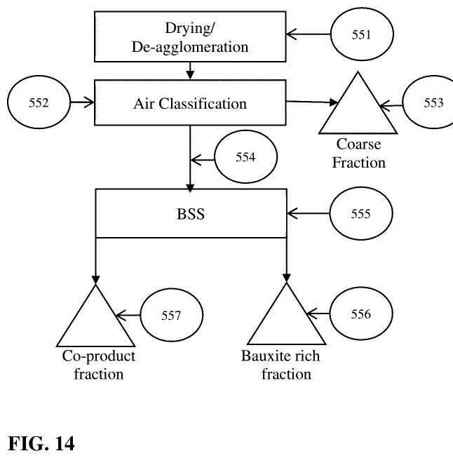

FIG. 14 illustrates another embodiment of a system and method, wherein the ore is suitably fine, but which contains high moisture. For these ores which are already suitably fine in particle size but contain high moisture, the process may entail a simultaneous drying and de-agglomeration stage (551) using an air swept, agitated flash dryer system. The ground bauxite powder, which has been dried to the suitable moisture content is introduced to a dynamic air classification system, or cyclone system (552) that performs a segregation based on particle size. At the air classification or cyclone system (552) the ground bauxite powder is split into a coarse particle size fraction (553) and a fine particle size fraction (554). The fine fraction from the air classification system (554) is then processed by a BSS (555) which fractionates the ore into a bauxite rich product (556) and a dry, bauxite-depleted co-product fraction (557). The coarse fraction (553) from the air classification system (552) may be further processed with suitable technology, including BSS.

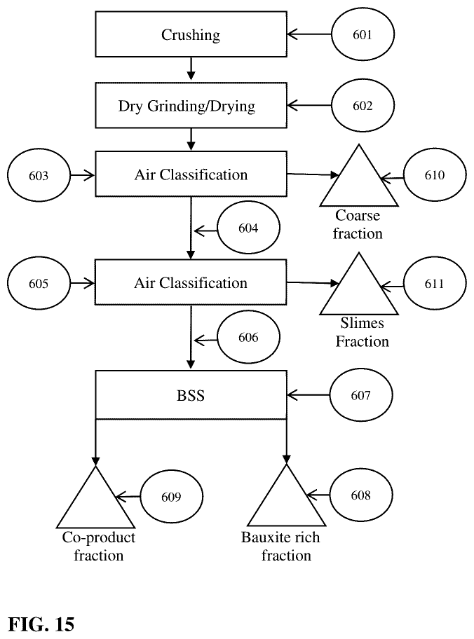

FIG. 15 illustrates another embodiment of a system and method, wherein the ore may be introduced to a crushing system (601) to reduce the ore to a particle size suitable for fine grinding. The crushing system is followed by a dry grinding and drying stage, which may be combined (602). This grinding and simultaneous drying may occur in an air swept milling device such as a vertical roller mill or an impact mill apparatus such as a hammer mill, rotor mill or pin mill. The ground bauxite powder, which has been dried to the suitable moisture content is split into a minimum of three particle size fractions (606, 610, 611) by two or more air classification systems (603, 605). A primary air separator (603) splits the dried bauxite ore into a fine particle size fraction (604) and coarse particle size fraction (610) which may be further processed with suitable technology, including BSS. The fine fraction (604) from the primary air classification system (603) is then separated in a secondary air classification system (605) whereby a coarser stream (606) and a slimes fraction (611) are generated. The coarser stream (606) from the secondary air classification system (605) is then processed by a BSS (607) which fractionates the ore into a bauxite rich product (608) and a dry, bauxite-depleted co-product fraction (609) suitable as an input to the manufacture of portland cement or cement clinker or may be stacked as dry tailings or moisture conditioned tailings. The slimes fraction (611) from the secondary air classification system (605) may be further processed with suitable technology, including BSS.

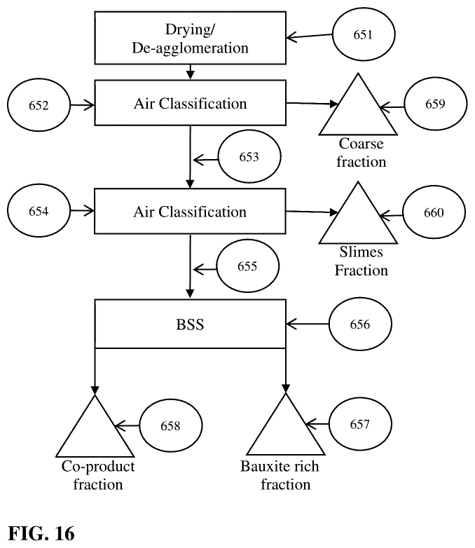

FIG. 16 illustrates another embodiment of a system and method, wherein the ore is suitably fine, but which contains high moisture. For these ores the process may entail a simultaneous drying and de-agglomeration stage (651) using an air swept, agitated flash dryer system. The ground bauxite powder, which has been dried to the suitable moisture content and is split into a minimum of three particle size fractions (655, 659, 660) by two or more air classification systems (652, 654). A primary air separator (652) splits the dried bauxite ore into a fine particle size fraction (653) and coarse particle size fraction (659) which may be further processed with suitable technology, including BSS. The fine fraction (653) from the primary air classification system (652) is then separated in a secondary air classification system (654) whereby a coarser stream (655) and a slimes fraction (660) are generated. The coarser stream (655) from the secondary air classification system (654) is then processed by a BSS (656) which fractionates the ore into a bauxite rich product (657) and a dry, bauxite-depleted co-product fraction (658). The slimes fraction (660) from the secondary air classification system (654) may be further processed with suitable technology, including BSS.

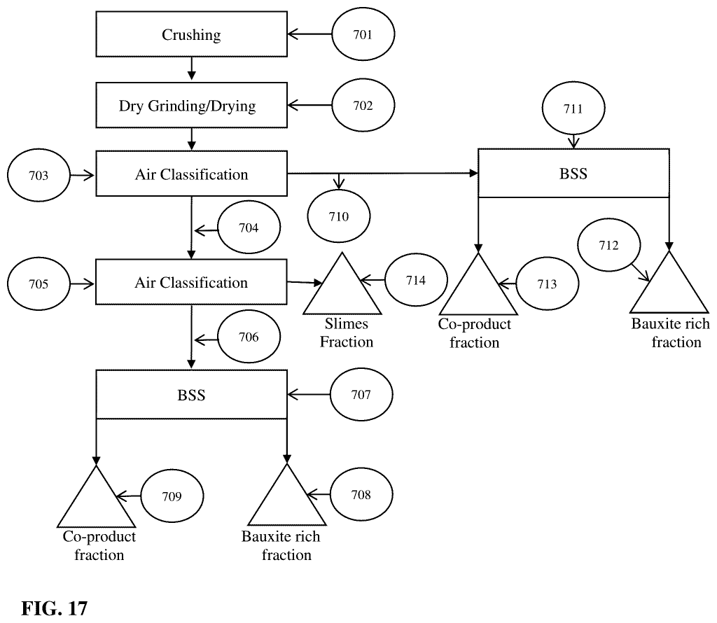

FIG. 17 illustrates another embodiment of a system and method, wherein the ore is introduced to a crushing system (701) to reduce the ore to a particle size suitable for fine grinding. The crushing system is followed by a dry grinding and drying stage, which may be combined (702). The ground bauxite powder, which has been dried to the suitable moisture content and is split into a minimum of three particle size fractions (706, 710, 714) by two or more air classification systems (703, 705). A primary air separator (703) splits the dried bauxite ore into a fine particle size fraction (704) and coarse particle size fraction (710). The coarse fraction (710) from the primary air classification system (703) is then processed by a BSS (711) which fractionates the ore into a bauxite rich product (712) and a dry, bauxite-depleted co-product fraction (713). The fine fraction (704) from the primary air classification system (703) is then separated in a secondary air classification system (705) whereby a coarser stream (706) and a slimes fraction (714) are generated. The coarser stream (706) from the secondary air classification system (705) is then processed by a BSS (707) which fractionates the ore into a bauxite rich product (708) and a dry, bauxite-depleted co-product fraction (709). The slimes fraction (714) from the secondary air classification system (705) may be further processed with suitable technology, including BSS. The dry, bauxite-depleted co-product fractions (713, 709) are suitable as an input to the manufacture of portland cement or cement clinker or may be stacked as dry tailings or moisture conditioned tailings.

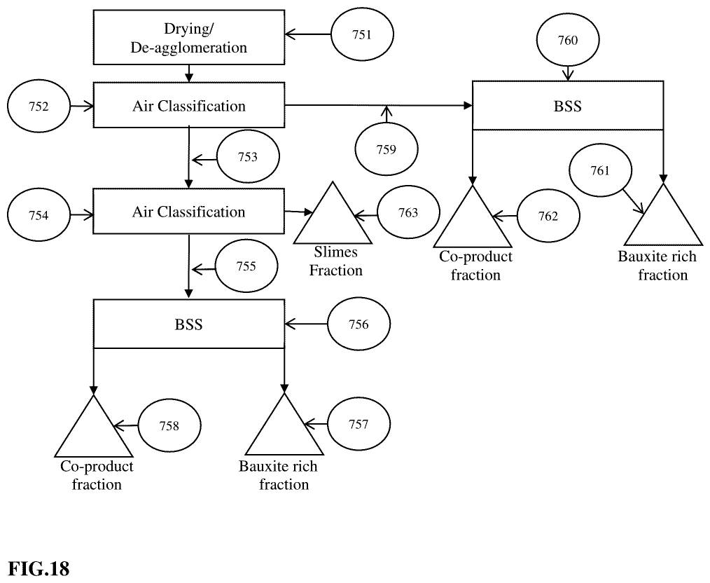

FIG. 18 illustrates another embodiment of a system and method, wherein the ore is suitably fine, but which contains high residual moisture, as in the case with tailings from wet processing. For these ores which are already suitably fine in particle size but contain high moisture, the process may entail a simultaneous drying and de-agglomeration stage (751) using an air swept, agitated flash dryer system. The ground bauxite powder, which has been dried to the suitable moisture content and is split into a minimum of three particle size fractions (755, 759, 763) by two or more air classification systems (752, 754). A primary air separator (752) splits the dried bauxite ore into a fine particle size fraction (753) and coarse particle size fraction (759). The coarse fraction (759) from the primary air classification system (752) is then processed by a BSS (760) which fractionates the ore into a bauxite rich product (761) and a dry, bauxite-depleted co-product fraction (762). The fine fraction (753) from the primary air classification system (752) is then separated in a secondary air classification system (754) whereby a coarser stream (755) and a slimes fraction (763) are generated. The coarser stream (755) from the secondary air classification system (754) is then processed by a BSS (756) which fractionates the ore into a bauxite rich product (757) and a dry, bauxite-depleted co-product fraction (758). The slimes fraction (763) from the secondary air classification system (754) may be further processed with suitable technology, including BSS. The dry, bauxite-depleted co-product product fractions (762, 758) are suitable as an input to the manufacture of portland cement or cement clinker or may be stacked as dry tailings or moisture conditioned tailings.

To attest the efficiency of the present invention, samples of bauxite ore were tested using the novel system.

### Example 1

In one example, upgrading of a sample of primarily monohydrate bauxite ore was completed by a series of processing stages comprising crushing of the ore, grinding of the ore to a finely ground powder using a hammer mill, drying of the ore to remove surface moisture, and processing the ground and dried ore using a tribo-electrostatic belt separator system (BSS). Table 1 shows the particle size distribution of the sample, measured by sieving, after crushing but prior to grinding.

TABLE 1

| | Weight Percent | Cumulative Weight Percent |
|---|---|---|
| Sieve | (%) Retained | (%) Passing |
| +3.4 mm | 53.7 | 46.3 |
| −3.4 mm/+2 mm | 9.5 | 36.8 |
| −2.0 mm/+1.4 mm | 5.2 | 31.6 |
| −1.4 mm/+1.0 mm | 4.4 | 27.2 |
| −1.0 mm/+850 μm | 1.4 | 25.8 |
| −850 μm/+710 μm | 2.1 | 23.7 |
| −710 μm/+600 μm | 1.9 | 21.8 |
| −600 μm/+425 μm | 4.3 | 17.5 |
| −425 μm/+355 μm | 2.3 | 15.2 |
| −355 μm/+300 μm | 1.9 | 13.3 |
| −300 μm/+250 μm | 1.9 | 11.4 |
| −250 μm/+180 μm | 2.8 | 8.6 |
| −180 μm | 8.6 | |

The ore was ground using a hammer mill and was subsequently dried from an initial moisture content of 2.5% to a moisture content less than 1.0%. The relative humidity (RH) of the bauxite ore feed to the BSS after drying was 46%. Table 2 shows the sample moisture, available alumina and reactive silica contents, and the sample particle size by laser diffraction measurement after grinding.

TABLE 2

| | | Loss on | | BSS Feed | Particle size by laser | | | |
|---|---|---|---|---|---|---|---|---|
| | Initial | Ignition, | BSS Feed | Relative | diffraction measurement | | | |
| | Moisture | LOI | Moisture | Humidity, RH | D10 | D50 | D90 | D98 |
| | (%) | (%) | (%) | (%) | (μm) | (μm) | (μm) | (μm) |
| Ground | 2.5 | 15.0 | <1.0 | 46 | 1 | 8 | 63 | 106 |
| Sample | | | | | | | | |

The major mineralogical phases of the feed sample are shown in Table 3. The sample exhibited a mineralogy typical of a monohydrate bauxite sample. The main Al2 O3 recoverable mineralogical species in the sample was Diaspore and the main gangue minerals were present in the form of Hematite, Goethite, Kaolinite, Quartz and Calcite.

TABLE 3

| Mineral | Chemical Formula | Weight Percent (%) |
|---|---|---|
| Gibbsite | Al(OH)₃ | 3.0 |
| Diaspore | AlO(OH) | 57.3 |
| Boehmite | AlO(OH) | 6.4 |
| Hematite | Fe₂O₃ | 8.2 |
| Goethite | FeO(OH) | 7.6 |
| Kaolinite | Al₂Si₂O₅(OH)₄ | 3.0 |
| Quartz | SiO₂ | 3.3 |
| Anatase | TiO₂ | 2.0 |
| Rutile | TiO₂ | 0.6 |
| Calcite | CaCO₃ | 8.6 |

The material which was processed by the BSS has a D50=8 micron and a D90=63 micron. BSS separation results are shown in Table 4.

TABLE 4
Example 1

| | | Available | Reactive | |
|---|---|---|---|---|
| | Weight | Al2O3 at 235 | Silica at 235 | Available Al2O3/ |
| | (%) | deg C. (%) | deg C. (%) | Reactive Silica |
| Feed | 100 | 41.8 | 6.7 | 6.2 |
| Concentrate | 41.8 | 46.4 | 3.7 | 12.5 |
| Tailings | 58.2 | 38.5 | 8.8 | 4.4 |

Table 4 shows that with the system of dry particle size reduction, drying and BSS processing, it was possible to obtain a concentrate with a 3.7% reactive silica and 46.4% available alumina, an available Al2O3 over reactive silica (A/S) ratio of 12.5.

### Example 2

In one example, processing of a sample of monohydrate bauxite ore was completed by a series of processing stages comprising grinding of the ore to a finely ground powder using a hammer mill, drying of the ore to remove surface moisture, and processing the ground and dried ore using a tribo-electrostatic belt separator system (BSS).

The ore was ground using a hammermill and subsequently dried. The relative humidity (RH) of the feed bauxite ore after drying was 4%. Table 5 shows the sample moisture, available alumina and reactive silica contents, and the sample particle size by laser diffraction measurement after grinding.

TABLE 5

| | Loss on | | | Particle size by laser | | | |
|---|---|---|---|---|---|---|---|
| | Ignition, | BSS Feed | BSS Feed | diffraction measurement | | | |
| | LOI | Moisture | RH | D10 | D50 | D90 | D98 |
| | (%) | (%) | (%) | (μm) | (μm) | (μm) | (μm) |
| Ground | 14.4 | 1.0 | 4 | 1 | 9 | 80 | 129 |
| Sample | | | | | | | |

The major mineralogical phases of the feed sample are shown in Table 6 below. The sample exhibited a mineralogy typical of a monohydrate bauxite sample. The main Al2O3 recoverable mineralogical species in the sample was Diaspore and the main gangue minerals were present in the form of Hematite, Goethite, Kaolinite, Quartz and Calcite.

TABLE 6

| Mineral | Chemical Formula | Weight Percent (%) |
|---|---|---|
| Gibbsite | Al(OH)₃ | 1.7 |
| Diaspore | AlO(OH) | 51.2 |
| Boehmite | AlO(OH) | 12.3 |
| Hematite | Fe₂O₃ | 10.1 |
| Goethite | FeO(OH) | 6.0 |
| Kaolinite | Al₂Si₂O₅(OH)₄ | 4.0 |
| Quartz | SiO₂ | 2.9 |
| Anatase | TiO₂ | 1.7 |
| Rutile | TiO₂ | 0.7 |
| Calcite | CaCO₃ | 6.9 |
| Muscovite | KAl₂(Si₃Al)O₁₀(OH,F)₂ | 2.1 |

The material which was processed by the BSS has a D50=9 micron and a D90=80 micron. BSS separation results are shown in Table 7.

TABLE 7
Example 2

| | | % Available | % Reactive | |
|---|---|---|---|---|
| | Weight | Al2O3 at 235 | Silica at 235 | Available Al2O3/ |
| | % | deg C. | deg C. | Reactive Silica |
| Feed | 100 | 39.1 | 8.6 | 4.5 |
| Concentrate | 38.0 | 48.3 | 4.0 | 12.1 |
| Tailings | 62.0 | 33.4 | 11.4 | 2.9 |

### Example 3

In one example, processing of a sample of trihydrate bauxite ore was completed by a series of processing stages comprising grinding of the ore to a finely ground powder, drying of the ore to remove surface moisture, processing the ground and dried ore using a tribo-electrostatic belt separator system (BSS).

Table 8 shows the sample moisture, available alumina and reactive silica contents, and the sample particle size by laser diffraction measurement after grinding. The ore was dried to a moisture content of 0.5%. The relative humidity (RH) of the feed bauxite ore after drying was 4%.

TABLE 8

| | | Loss on | | Particle size by laser | | | |
|---|---|---|---|---|---|---|---|
| | | Ignition, | BSS Feed | diffraction measurement | | | |
| | Moisture | LOI | RH | D10 | D50 | D90 | D98 |
| | (%) | (%) | (%) | (μm) | (μm) | (μm) | (μm) |
| Ground | 0.5 | 23.6 | 4 | 2 | 19 | 73 | 118 |
| Sample | | | | | | | |

The major mineralogical phases of the feed sample are shown in Table 9 below. The sample exhibited a mineralogy typical of a trihydrate bauxite sample. The main Al2O3recoverable mineralogical species in the sample was Gibbsite and the main gangue minerals were present in the form of Hematite, Goethite, Kaolinite and Quartz.

TABLE 9

| Mineral | Chemical Formula | Weight Percent (%) |
|---|---|---|
| Gibbsite | Al(OH)₃ | 61.1 |
| Hematite | Fe₂O₃ | 14.9 |
| Goethite | FeO(OH) | 11.0 |
| Kaolinite | Al₂Si₂O₅(OH)₄ | 8.7 |
| Quartz | SiO₂ | 1.3 |
| Ilmenite | FeTiO₃ | 0.6 |
| Anatase | TiO₂ | 0.8 |
| Amorphous | — | 1.5 |

The material which was processed by the BSS has a D50=19 micron and a D90=73 micron. BSS separation results are shown in Table 10.

TABLE 10
Example 3

| | | % Available | % Reactive | |
|---|---|---|---|---|
| | Weight | Al2O3 at 145 | Silica at 145 | Available Al2O3/ |
| | % | deg C. | deg C. | Reactive Silica |
| Feed | 100 | 35.9 | 3.6 | 10.0 |
| Concentrate | 40 | 43.2 | 2.5 | 17.3 |
| Tailings | 60 | 31.1 | 4.4 | 7.1 |

### Example 4

In one example, processing of a sample of trihydrate bauxite ore tailings which was collected as undersize from a traditional wet screening process was completed by a series of processing stages comprising (i) drying of the high moisture lumps (ii) crushing with a jaw crusher to break up agglomerates (iii) de-agglomerating the lumps into a fine powder and (iv) drying of the fine powder to the appropriate moisture and relative humidity level for BSS processing.

Table 11 shows the sample moisture, LOI and the sample particle size by laser diffraction measurement after grinding and de-agglomerating. The ore was dried from an initial moisture content of 26.7% to a moisture content of 0.8%. The relative humidity (RH) of the feed bauxite ore after drying was <1%.

TABLE 11

| | | Loss on | | BSS Feed | Particle size by laser | | | |
|---|---|---|---|---|---|---|---|---|
| | Initial | Ignition, | BSS Feed | Relative | diffraction measurement | | | |
| | Moisture | LOI | Moisture | Humidity, RH | D10 | D50 | D90 | D98 |
| | (%) | (%) | (%) | (%) | (μm) | (μm) | (μm) | (μm) |
| Ground | 26.7 | 18.8 | 0.8 | <1 | 1 | 7 | 59 | 93 |
| Sample | | | | | | | | |

The major mineralogical phases of the feed sample are shown in Table 12 below. The sample exhibited a mineralogy typical of a trihydrate bauxite sample. The main Al2O3 recoverable mineralogical species in the sample was Gibbsite and the main gangue minerals were present in the form of Hematite, Goethite, Kaolinite, Ilmenite and Quartz.

TABLE 12

| Mineral | Chemical Formula | Weight Percent (%) |
|---|---|---|
| Gibbsite | Al(OH)₃ | 40.7 |
| Hematite | Fe₂O₃ | 4.2 |
| Goethite | FeO(OH) | 17.4 |
| Kaolinite | Al₂Si₂O₅(OH)₄ | 10.9 |
| Quartz | SiO₂ | 19.0 |
| Ilmenite | FeTiO₃ | 5.8 |
| Anatase | TiO₂ | 1.0 |
| Zircon | ZrSiO4 | 1.0 |

The material which was processed by the BSS has a D50=7 micron and a D90=59 micron. BSS separation results are shown in Table 13.

TABLE 13
Example 4

| | | % Available | % Reactive | |
|---|---|---|---|---|
| | Weight | Al2O3 at 145 | Silica at 145 | Available Al2O3/ |
| | % | deg C. | deg C. | Reactive Silica |
| Feed | 100 | 24.1 | 5.0 | 4.8 |
| Concentrate | 43.3 | 32.6 | 3.6 | 9.1 |
| Tailings | 56.7 | 17.6 | 6.0 | 2.9 |

### Example 5

In one example, processing of a sample of trihydrate bauxite ore was completed by a series of processing stages comprising grinding of the ore to a finely ground powder, drying of the ore to remove surface moisture, processing the ground and dried ore using a tribo-electrostatic belt separator system (BSS).

Table 14 shows the sample moisture, available alumina and reactive silica contents, and the sample particle size by laser diffraction measurement after grinding. The ore was dried from an initial moisture content of 1.0% to a moisture content of 0.8%. The relative humidity (RH) of the feed bauxite ore after drying was <1%.

TABLE 14

| | | Loss on | | BSS Feed | Particle size by laser | | | |
|---|---|---|---|---|---|---|---|---|
| | Initial | Ignition, | BSS Feed | Relative | diffraction measurement | | | |
| | Moisture | LOI | Moisture | Humidity, RH | D10 | D50 | D90 | D98 |
| | (%) | (%) | (%) | (%) | (μm) | (μm) | (μm) | (μm) |
| Ground | 1.0 | 22.7 | 0.8 | <1 | 1 | 8 | 67 | 98 |
| Sample | | | | | | | | |

The major mineralogical phases of the feed sample are shown in Table 15 below. The sample exhibited a mineralogy typical of a trihydrate bauxite sample. The main Al2O3 recoverable mineralogical species in the sample was Gibbsite and the main gangue minerals were present in the form of Hematite, Goethite, Kaolinite and Quartz.

TABLE 15

| Mineral | Chemical Formula | Weight Percent (%) |
|---|---|---|
| Gibbsite | Al(OH)₃ | 58.9 |
| Hematite | Fe₂O₃ | 1.6 |
| Goethite | FeO(OH) | 6.1 |
| Kaolinite | Al₂Si₂O₅(OH)₄ | 4.4 |
| Quartz | SiO₂ | 24.7 |
| Ilmenite | FeTiO₃ | 1.9 |
| Zircon | ZrSiO₄ | 0.8 |
| Amorphous | — | 1.5 |

The material which was processed by the BSS has a D50=8 micron and a D90=67 micron. BSS separation results are shown in Table 16.

TABLE 16
Example 5

| | | % Available | % Reactive | |
|---|---|---|---|---|
| | Weight | Al2O3 at 145 | Silica at 145 | Available Al2O3/ |
| | % | deg C. | deg C. | Reactive Silica |
| Feed | 100 | 38.6 | 3.7 | 10.4 |
| Concentrate | 28.6 | 50.2 | 3.8 | 13.2 |
| Tailings | 71.4 | 34.0 | 3.6 | 8.6 |

Having thus described certain embodiments of a system for beneficiation of bauxite ore; various alterations, modifications and improvements will be apparent to those of ordinary skill in the art. Such alterations, variations and improvements are intended to be within the spirit and scope of the application. Accordingly, the foregoing description is by way of example and is not intended to be limiting. The application is limited only as defined in the following claims and the equivalents thereto.

What is claimed is:

1. A method for beneficiation of bauxite ore, comprising:
providing a source of bauxite ore;
drying the bauxite ore to achieve a moisture content of less than about 4.0% by weight; and
separating the bauxite ore with a triboelectric electrostatic belt separator or belt separator system (BSS) to generate a bauxite rich concentrate which is enriched in total Al2O3 and/or available alumina, and reduced in total SiO₂ and/or reactive silica, whereby the step of drying the bauxite ore enhances the step of separating, and
wherein the method is carried out without adding water.

2. The method of claim 1, wherein the source of bauxite ore is characterized by a d90 particle size of about 200 microns or less.

3. The method of claim 1, wherein the source of bauxite ore is characterized by a moisture content of greater than about 10% by weight.

4. The method of claim 1, wherein the method is carried out in a completely dry metallurgical route.

5. The method of claim 1, further comprising grinding the source of bauxite ore such that 90% of the bauxite ore particles (d90) are finer than about 200microns.

6. The method of claim 1, wherein the method further comprises mechanically de-agglomerating the dried bauxite ore prior to separation using a high shear impact device.

7. The method of claim 5, wherein the grinding and drying of the bauxite ore are conducted in the same apparatus.

8. The method of claim 6, where the drying and mechanical de-agglomeration of the bauxite ore are conducted in the same apparatus.

9. The method of claim 1, wherein the source of bauxite ore is a monohydrate or a trihydrate bauxite ore.

10. The method of claim 1, wherein the source of bauxite ore is a metallurgical grade bauxite ore.

11. The method of claim 1, wherein the source of bauxite ore is a non-metallurgical grade bauxite ore.

12. The method of claim 1, further comprising introducing the bauxite rich concentrate to an alumina refining operation or Bayer process.

13. The method of claim 1, wherein the separating step further generates a co-product suitable for use in the manufacturing of cement or cement clinker.

14. The method of claim 13, wherein the co-product does not require pretreatment to remove sodium prior to being used to manufacture cement clinker or cementitious products.

15. The method of claim 1, further comprising storing a co-product of the separating step as stackable dry tailings.

16. The method of claim 1, wherein the bauxite ore is beneficiated at a rate of feed greater than about 37 tons per hour per meter of electrode width.

17. The method of claim 1, wherein the bauxite rich concentrate is characterized by less than about 4% reactive silica by weight, e.g. about 3% reactive silica.

18. The method of claim 1, wherein the amount of iron present in the bauxite rich product is reduced by about 0% to about 30% on a relative basis.

19. The method of claim 1, wherein the amount of titania (TiO₂) present in the bauxite rich product is reduced by about 0% to about 75% on a relative basis.

20. The method of claim 1, wherein the amount of kaolinite present in the bauxite rich product is reduced by about 0% to about 50% on a relative basis.

21. The method of claim 1, wherein the amount of quartz present in the bauxite rich product is reduced by about 20% to about 80% on a relative basis.

22. The method of claim 1, wherein an amount of reactive silica present per unit of available alumina is reduced by about 10% to about 65% on a relative basis.

23. The method of claim 1, wherein a ratio of bauxite to available alumina is decreased by between about 8% and about 27% in relative terms.

24. The method of claim 1, wherein a ratio of available alumina to reactive silica in the bauxite rich product (A/S) is increased by between about 20% and about 200% in relative terms.

25. The method of claim 1, wherein a ratio of bauxite to total Al₂O₃ is decreased by between about 2% and about 30% in relative terms.

26. The method of claim 1, wherein the BSS is a first BSS stage, and wherein a dry, bauxite-depleted co-product from the first BSS stage is processed by a second BSS stage in a scavenging configuration in which the bauxite rich product from the second BSS is returned as feed to the first BSS stage.

27. The method of claim 1, wherein the BSS is a first BSS stage, and wherein a dry, bauxite-depleted co-product from the first BSS stage is processed by a second BSS stage in a scavenging configuration.

28. The method of claim 1, wherein the BSS is a first BSS, and wherein a bauxite concentrate from the first BSS is processed by a second BSS in a cleaning configuration.

29. The method of claim 1, wherein the BSS is a first BSS, and wherein a dry, bauxite-depleted co-product from the first BSS is processed by a second BSS in a scavenging configuration in which the bauxite rich product from the second BSS is returned as feed to the first BSS, and in which the bauxite rich concentrate from the first BSS is processed by the second BSS in a cleaning configuration.

30. The method of claim 1, wherein the BSS is a first BSS, and wherein a dry, bauxite-depleted co-product from the first BSS is processed by a second BSS in a scavenging configuration, and in which the bauxite rich concentrate from the first BSS is processed by the second BSS in a cleaning configuration.

31. The method of claim 1, wherein the BSS is a first BSS, and wherein a dry, bauxite-depleted co-product from the first BSS is processed by a second BSS in a scavenging configuration in which the bauxite rich product from the second BSS is returned as feed to the first BSS.

32. The method of claim 1, wherein the BSS is a first BSS, and wherein a dry, bauxite-depleted co-product from the first BSS is processed by a second BSS in a scavenging configuration.

33. The method of claim 1, further comprising air classifying the bauxite ore to provide a fine fraction and a coarse fraction, and wherein either or both the fine fraction or the coarse fraction from the air separator classification system is processed with the BSS to generate the bauxite rich concentrate which is enriched in total Al₂O₃ and/or available alumina, and reduced in total SiO₂ and/or reactive silica.

34. The method of claim 33, wherein the fine fraction is processed with the BSS to generate the bauxite rich concentrate which is enriched in total Al₂O₃ and/or available alumina, and reduced in total SiO2 and/or reactive silica.

35. The method of claim 33, further comprising introducing the fine fraction to at least one further air separator classification device.

36. The method of claim 33, wherein the coarser fraction(s) from one or more further air classification stages preceding a final air classification stage are processed via BSS.

37. The method of claim 35, wherein the coarse fraction from the final air classification stage is processed via BSS.

38. The method of claim 1, wherein the bauxite ore is dried to a moisture content of less than about 2.0% by weight.
